(19) United States
(12) Patent Application Publication
(10) Pub. No.: US 2016/0263496 A1
(43) Pub. Date: Sep. 15, 2016

(54) Filter Element, in Particular for Liquid Filtration

(71) Applicant: MANN+HUMMEL GMBH, Ludwigsburg (DE)

(72) Inventors: Horst Croissant, Hochstadt (DE); Michael Wolf, Neunkirchen (DE)

(21) Appl. No.: 15/064,993

(22) Filed: Mar. 9, 2016

(30) Foreign Application Priority Data
Mar. 9, 2015 (DE) 10 2015 002 901.0

(51) Int. Cl. B01D 29/33; B01D 35/00; B01D 63/02

(52) U.S. Cl. CPC B01D 29/33; B01D 63/02; B01D 35/005

(57) ABSTRACT

A filter element has a hollow cylindrical filter medium body and an end plate on the face side, on which an annular shoulder is formed, on which a stop membrane is supported.

### TECHNICAL AREA

The invention relates to a filter element, in particular for liquid filtration, according to the preamble of claim 1.

### BACKGROUND

From U.S. Pat. No. 5,362,390, an oil filter having a hollow cylindrical filter element is known, which is received in a filter housing and through which the oil flows radially from the outside towards the inside. A lid is placed on the filter housing, in which flow openings for the supply of unfiltered oil are provided. On the face side of the filter element, an annular stop membrane has been placed that has a membrane spigot as well as a circumferential membrane lip that extends radially outwards, the external face side of which rests against the lid. The inflowing unfiltered oil presses the membrane lip on, so that the flow path to the unfiltered side of the filter element, which is formed by the outer lateral surface, is unblocked. The membrane spigot of the stop membrane is seated on a dome-shaped annular shoulder, which is located on an end plate of the filter element and protrudes on the axial face side. An inwardly directed collar on the membrane spigot rests against the face side of the annular shoulder and is pressed axially against the annular shoulder by the lid resting thereon.

### SUMMARY

The invention is based on the object of forming a filter element in such a way that the unfiltered side is effectively separated from the filtered side.

The filter element according to the invention is preferably used for liquid filtration, for example in an oil filter in an internal combustion engine. However, its use in gas filters is also contemplated.

The filter element has a hollow cylindrical filter medium body, through which the fluid to be filtered flows in the radial direction, in particular radially from the outside towards the inside, so that the radially outer lateral surface forms the unfiltered side and the cylindrical inner space forms the filtered side, from which the filtered fluid is axially discharged. The filter medium body is covered by an end plate on at least one face side, preferably on both face sides. On an end plate, an annular shoulder is provided which is formed either integrally with the end plate or separately from the end plate but is connected to the latter. The annular shoulder forms for example a dome that protrudes axially beyond the face side of the filter medium body and borders in particular directly on to the inner space or to the opening in the end plate that corresponds to the inner space.

A stop membrane is placed on top of the annular shoulder on the filter element, which stop membrane is designed as a separate component and consists, as in the case of a sealing element, of a relatively soft, elastically flexible material, preferably an elastomer. The stop membrane has the function of separating, in the installed condition of the filter element, the unfiltered side from the filtered side.

The stop membrane comprises a membrane spigot that is designed to be cylindrical and engages around the annular shoulder on the face side of the filter medium body, as well as a membrane lip that extends radially outwards from the membrane spigot and runs on the membrane spigot in a ring-shaped manner. In the installed condition, the membrane lip rests against the inside of a lid placed on the filter housing and is pressed on by the pressure of the inflowing fluid, as a result of which the flow path to the unfiltered side of the filter element is unblocked. Conversely, the membrane lip closes the inflow opening if the pressure on the opposite side of the membrane lip rises, for example in an upside-down position of the filter unit, as a result of which any undesired escape of fluid from the filter unit is prevented.

The membrane spigot is designed to be cylindrical and preferably includes at least one contact pad that protrudes radially inwards on the inner side thereof, which contact pad rests against the outer lateral surface of the annular shoulder, on which the membrane spigot is placed. The contact pad applies a radial force onto the annular shoulder, which is increased due to the relatively small contact area between the contact pad and the lateral surface of the annular shoulder. Correspondingly, an enhanced radial sealing effect is achieved and any undesired flow of the fluid along the outer lateral surface of the annular shoulder is prevented.

In a preferred embodiment, the annular shoulder is formed in one piece and from a material that is matched to that of the end plate. Further, the annular shoulder is preferably tubular and in particular closed. Preferably, the end plate is made from metal or plastic.

In a further preferred embodiment, the annular shoulder and/or the membrane spigot may, on the side facing away from the filter medium body, extend axially away from the filter medium body, in particular axially beyond the membrane lip.

Particularly preferably, the annular shoulder and the membrane spigot extend axially beyond the membrane lip and each have axial front faces designed such that they can form, substantially next to each other and parallel to each other in a plane extending in particular perpendicularly to the axial extension of the hollow cylindrical filter body, a common abutment face, in particular for abutment against a lid. In this regard, the membrane spigot can, in the uninstalled condition, extend axially slightly beyond the annular shoulder, in particular by an amount that is necessary for achieving a sealing effect, by elastically pressing the membrane spigot against a counter surface, in particular the lid. As a result, it can advantageously be achieved that the axial face sides of the membrane spigot, which face away from the filter medium body, and of the annular shoulder rest against the lid next to each other, in particular flush, in particular without any mutual overlapping in an axial direction. In this regard, the axial face side of the membrane spigot rests against the lid preferably in a sealing manner.

An axial face side of the membrane spigot is supported on the filter element or on a component connected to the filter element. This may preferably be the end plate or the transition between the annular shoulder and the end plate which is, if present, formed as a groove-shaped depression and is used for receiving the face side of the membrane spigot.

In the assembled condition, the axially opposite face side of the membrane spigot rests against the inner surface of the lid and a force is applied thereto by the lid in the axial direction. This face side of the membrane spigot is located in the axial extension of the inside of the membrane spigot that includes the contact pad. The membrane spigot is designed to be cylindrical, so that the force applied by the lid onto the face side in the axial direction—in relation to the longitudinal axis of the membrane spigot—is transmitted via the wall of the membrane spigot in the axial direction up to the opposite face side. Thus, both in the axial direction and in the radial direction, a sealing effect with correspondingly improved sealing between the unfiltered side and the filtered side of the filter element is achieved. Any creepage flows between the stop membrane and the lateral surface of the annular shoulder can be reliably avoided. The radial sealing effect is moreover improved as a result of the fact that, due to the axial compression of the membrane spigot, the contact pad is additionally pressed against the lateral surface of the annular shoulder with a radial force.

According to an advantageous embodiment, the face side of the membrane spigot that faces the lid is designed to have a smaller extension transversely to the longitudinal axis than the opposite axial end side that is supported on the filter element. In principle it is sufficient for the face side of the membrane spigot that faces the lid to have the same cross-sectional area as a central section of the wall of the membrane spigot, without being radially widened. The face side that faces the lid is not clamped between the annular shoulder and the lid, but has merely a force applied to it by the lid in the axial direction. This avoids any inadvertent shearing off of a section of the stop membrane.

According to a further advantageous embodiment, the axial face side of the membrane spigot that is supported on the filter element has a larger cross section than the opposite axial face side. Correspondingly, the axial force on the filter element side is spread over a larger area. This axial face side can, according to a further advantageous embodiment, be designed to be rounded to form a face-side section, it can in particular have a part-circular cross section, which is preferably matched to the cross section of the groove-shaped depression in the transition between the end plate and the annular shoulder. As a result, the face side of the membrane spigot that faces the filter element is guided and supported both in the axial direction and in the radial direction.

According to a further advantageous embodiment, a support surface facing the membrane lip is provided on the face-side section that faces the filter element, on which the membrane lip may be supported. The support surface is preferably designed to be planar and is, in the unloaded condition of the stop membrane, axially spaced apart from the membrane lip. As soon as the membrane lip is pushed up by the inflowing fluid, the lateral surface of the membrane lip that faces away from the fluid comes into contact with the support surface on the face side of the membrane spigot and is as a result supported. The pushing up of the membrane lip is restricted and the membrane lip can more easily return into its initial position, in which the free face side of the membrane lip rests against the bottom side of the lid. As an alternative to a flat support surface, also a curved support surface may be considered. The support surface may be located in particular on the side of the widened section of the membrane spigot that faces away from the face side.

Advantageously, the contact pad runs on the inside of the membrane spigot in a ring-shaped manner. However, also embodiments with a plurality of individual contact pads that are spread over the circumference on the inside of the membrane spigot or where a circumferential contact pad is interrupted in one or more places are possible. It may further be expedient to provide at least two axially spaced-apart contact pads on the inside of the membrane spigot, each of which is in contact with the lateral surface of the annular shoulder. As a result, an altogether improved radial sealing effect is achieved. The two contact pads may be designed in the same way and may for example have a part-circular cross section.

According to a further advantageous embodiment, the contact pads are located, if viewed in the axial direction, between the branching point of the membrane lip on the membrane spigot and the face side of the membrane spigot that faces the lid. According to an advantageous embodiment, in the unloaded condition, the free face side of the membrane lip is located axially between the opposite face sides of the membrane spigot, however closer to the face side of the membrane spigot that faces the lid.

The filter unit, which comprises the filter element, is preferably a liquid filter, in particular a replacement filter of the spin-on type, for example designed as an oil filter. The filter unit has a filter housing for receiving the filter element as well as a lid that can be placed on the filter housing, which in the assembled condition applies an axial force onto the locking membrane.

### BRIEF DESCRIPTION OF THE DRAWINGS

Further advantages and advantageous embodiments can be seen from the further claims, the description of the figures and the drawings, wherein:

FIG. 1 shows a section through a filter unit for liquid filtration, comprising a hollow cylindrical filter element received in a filter housing, on the face side of which a stop membrane is provided,

FIG. 2 shows a detailed sectional view of the stop membrane.

In the figures, the same components have been provided with the same reference signs.

### DETAILED DESCRIPTION

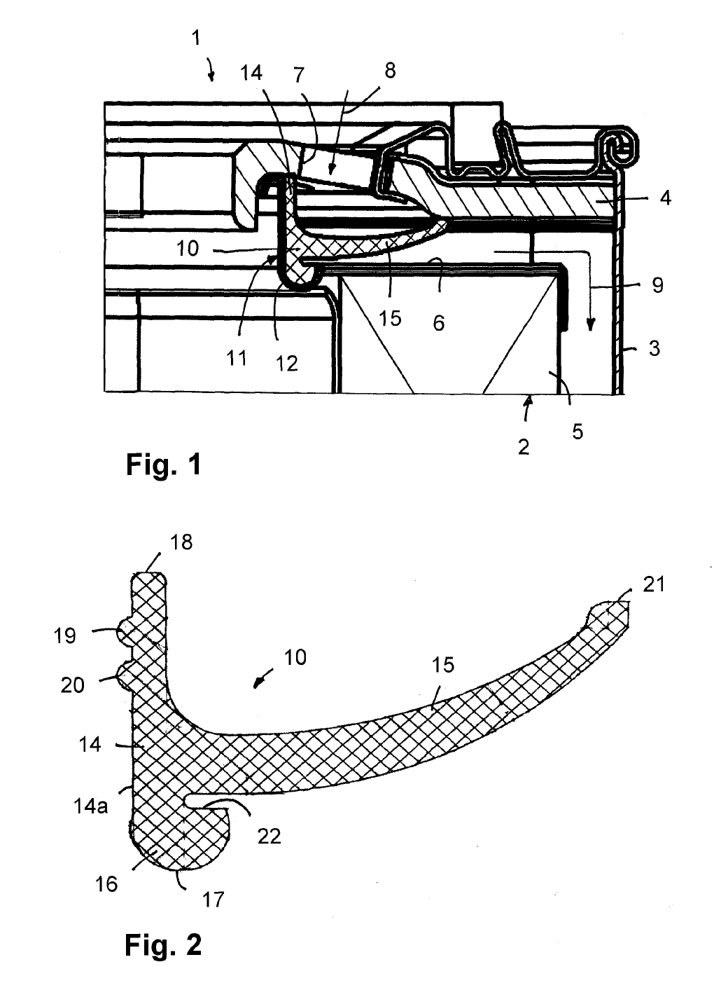

FIG. 1 shows a filter unit 1 for liquid filtration, in particular for oil filtration, which is designed as a spin-on filter. The filter unit 1 comprises a filter element 2 that is received in a filter housing 3 that can be closed with a lid 4. In the case of spin-on filters, as in this embodiment, it is as a rule provided that the filter housing 3 cannot be opened, i.e. the lid 4 is non-detachably (in the present embodiment using a flange) connected to the filter housing 3. Thus, the spin-on filter 1 as a whole forms a replaceable unit. This design is therefore also referred to as a replacement filter. However, a filter element 2 as described above may also be used in filter housings that can be opened. The filter element 2 comprises a hollow cylindrical filter medium body 5, through which the fluid flows radially from the outside towards the inside and which is covered on the end side thereof by an end plate 6. The opposite end side of the filter medium body 5 is preferably also covered by an end plate. Due to the fact that fluid flows radially through the filter element 2 from the outside towards the inside, the outer lateral surface of the filter medium body 5 forms the unfiltered side and the cylindrical inner space forms the filtered side, from which the filtered fluid is axially discharged.

A plurality of inflow openings 7 spread over the circumference is provided in the lid 4, through which inflow openings 7 the unfiltered fluid is axially supplied to the filter unit 1 according to arrow 8. Subsequently, the fluid flows along the upper end plate 6 radially outwards and, according to arrow 9, axially into the outer annular space between the inner wall of the filter housing 3 and the outer lateral surface of the hollow cylindrical filter medium body 5, from where the medium passes radially through the filter medium body 5 from the outside inwards.

For separating the unfiltered side from the filtered side, the filter element 2 is provided with a stop membrane 10 that is placed on an annular shoulder 11, which is integrally formed with the upper end plate 6 and is located as an axially protruding dome in the region of the opening in the end plate 6, which is in communication with the inner space in the filter medium body 5 that forms the filtered space. The annular shoulder 11 is designed as hollow cylindrical and is connected to the end plate 6 via a groove-shaped depression 12 that extends axially into the filtered space. A face-side section 16 of the stop membrane 10 protrudes into the groove-shaped depression 12 that has a part-circular cross section.

As can be seen in FIG. 1 in conjunction with FIG. 2, the stop membrane 10 comprises a cylindrical membrane spigot 14 as well as a circumferential membrane lip 15 that extends radially outwards from the membrane spigot 14. The cylindrical membrane spigot 14 sits on the annular shoulder 11, so that the inside 14a of the membrane spigot 14 rests against the outer lateral surface of the annular shoulder 11. The bottom face side 17 of the membrane spigot 14 is located on a face-side section 16 that has, in the radial direction transversely to the longitudinal axis of the membrane spigot 14, a greater extension than the remaining wall sections of the membrane spigot. In the assembled condition, the face-side section 16, which has a part-circular cross-sectional contour, rests against the groove-shaped depression 12.

On the inner side 14a of the membrane spigot 14 are located two contact pads 19 and 20, which run circumferentially in a ring-shaped manner, each of which have a part-circular cross section and which, in the unloaded condition, protrude radially inwards beyond the inner side 14a. In the assembled condition, the inner side 14a of the membrane spigot 14 rests against the outer lateral surface of the cylindrical annular shoulder 11 in a planar manner, with an enhanced radial force acting in the region of the contact pads 19 and 20 between the membrane spigot 14 and the annular shoulder 11, which leads to an enhanced sealing between the annular shoulder and the membrane spigot.

The face side 18 of the membrane spigot 14, which faces away from the filter element 2, has an axial force applied thereto by the inner side of the lid 4 and is pressed in the direction of the filter element 2. The axial force presses the bottom face-side section 16 into the groove-shaped depression 12 and also effects an improved sealing between the stop membrane and the annular shoulder.

The membrane lip 15 is integrally formed with the membrane spigot 14 and is axially branched off from the membrane spigot between the widened face-side section 16 and the axially bottom contact pad 20. In the unloaded condition (FIG. 2), the free face side 21 of the membrane lip is located, which has a bent cross section and extends in the direction of the upper face side 18 on the membrane spigot 14 at an axial distance from the face side 18.

A first support surface 22 is provided on the radially widened face-side section 16 on the membrane spigot 14, which support surface faces the membrane lip 15. In the unloaded condition, there is a gap between the support surface 22, which is designed as a flat surface, and the adjacent membrane lip 15. As soon as the membrane lip 15 is bent downwards by the pressure of the inflowing medium, in order to unblock the flow path according to arrows 8 and 9, the lateral surface of the membrane lip 15 comes into abutment with the support surface 22 on the end-side section 16, as a result of which any further push-up movement of the membrane lip 15 is limited.

What is claimed is:

1. A filter element for liquid filtration, comprising:
a filter medium forming a hollow cylindrical filter medium body encircling a central axis extending through a hollow interior of the hollow cylindrical filter medium body between axially opposing end faces of the cylindrical filter medium body, the central axis defining an axial direction;
an end plate secured on and covering at least axial one end face of the hollow cylindrical filter medium body, the end plate including:
an annular shoulder;
an elastomeric stop membrane arranged on the annular shoulder, the stop membrane including
an annular membrane spigot formed at one end of the stop membrane;
an annular membrane lip formed at a second end of the stop membrane;
wherein the membrane lip extends circumferentially around the membrane spigot;
wherein the membrane lip extends radially outwardly from the membrane spigot;
wherein the membrane spigot is arranged directly on and engages around the annular shoulder;
wherein the membrane spigot is designed to be cylindrical;
wherein an axial face side of the membrane spigot is supported on the filter element and the axially opposite face side of the membrane spigot is formed by an axial outward extension of a radially inner side of the membrane spigot.

2. The filter element according to claim 1, wherein
on the radial inner side of the membrane spigot, at least one contact pad is provided, which rests against the annular shoulder and protrudes radially inwards, and
wherein the axially opposite face side of the membrane spigot is arranged in the axial extension of the inner side of the membrane spigot that has the contact pad.

3. The filter element according to claim 1, wherein
the annular shoulder is formed integrally together with and of the same material of the end plate.

4. The filter element according to claim 1, wherein
the annular shoulder and/or the membrane spigot extend axially outwardly away from the filter medium body on a side that faces away from the filter medium body.

5. The filter element as claimed in claim 4, wherein
the annular shoulder and/or the membrane spigot extend axially outwardly beyond the membrane lip.

6. The filter element as claimed in claim 4, wherein
the annular shoulder and the membrane spigot extend axially outwardly beyond the membrane lip and each have axial front faces that are designed such that they can form a common support surface for resting against a lid, the annular shoulder and the membrane spigot substantially next to each other and parallel to each other in one plane.

7. The filter element as claimed in claim 1,
wherein the axial face side of the membrane spigot, which is supported on the filter element, has a greater extension transversely to the longitudinal axis than the opposite axial face side of the membrane spigot.

8. The filter element as claimed in claim 1, wherein the axial face side of the membrane spigot that faces the filter element is received in and supported on a groove-shaped depression in a transition between the end plate and the annular shoulder.

9. The filter element as claimed in claim 1, wherein
the axial face side of the membrane spigot has a face-side section supported on the filter element;
wherein the face side section has a support surface facing the membrane lip for supporting the membrane lip.

10. The filter element as claimed in claim 9, wherein
the support surface is substantially planar on the membrane spigot and, in an unloaded condition of the stop membrane, is located at a position spaced axially away from the membrane lip.

11. The filter element as claimed in claim 1, wherein
in the unloaded condition, a free face side at a radially outer end of the membrane lip is located axially between the face side and the opposite face side of the membrane spigot.

12. The filter element as claimed in claim 2, wherein
the at least one contact pad is annular, formed so as to run circumferentially in a ring-shaped manner on a radially inner side of the membrane spigot.

13. The filter element as claimed in claim 12, wherein
at least two axially spaced-apart contact pads are provided on the radially inner side of the membrane spigot.

14. The filter element as claimed in claim 1, wherein
the at least two axially spaced-apart contact pads are located axially between a branching point of the membrane lip and the axial face side of the membrane spigot.

15. A replaceable filter unit of the spin-on type, comprising:
a filter housing, including
a cup shaped housing
a lid secured to the housing an closing over an open end of the cup shaped housing;
a filter element received within the filter housing, the filter element including:
a filter medium forming a hollow cylindrical filter medium body encircling a central axis extending through a hollow interior of the hollow cylindrical filter medium body between axially opposing end faces of the cylindrical filter medium body, the central axis defining an axial direction;
an end plate secured on and covering at least axial one end face of the hollow cylindrical filter medium body, the end plate including:
an annular shoulder;
an elastomeric stop membrane arranged on the annular shoulder, the stop membrane including
an annular membrane spigot formed at one end of the stop membrane;
an annular membrane lip formed at a second end of the stop membrane;
wherein the membrane lip extends circumferentially around the membrane spigot;
wherein the membrane lip extends radially outwardly from the membrane spigot;
wherein the membrane spigot is arranged directly on and engages around the annular shoulder;
wherein the membrane spigot is designed to be cylindrical;
wherein an axial face side of the membrane spigot is supported on the filter element and the axially opposite face side of the membrane spigot is formed by an axial outward extension of a radially inner side of the membrane spigot.

16. The replaceable filter unit according to claim 15, wherein
the axial face side of the membrane spigot rests directly on and seals to an inner side of the lid.

17. The replaceable filter unit according to claim 15, wherein
the axial face side of the membrane spigot that faces away from the filter medium body and the axial face side of the annular shoulder that faces away from the filter medium body, both contact and rest on the lid next to each other flush without any mutual overlapping in the axial direction.
